(19) United States
(12) Patent Application Publication
(10) Pub. No.: US 2015/0227073 A1
(43) Pub. Date: Aug. 13, 2015

(54) ELECTROSTATIC IMAGE DEVELOPING TONER, ELECTROPHOTOGRAPHIC CARTRIDGE PROVIDED WITH SAID TONER, AND IMAGE FORMING DEVICE

(71) Applicant: MITSUBISHI CHEMICAL CORPORATION, Tokyo (JP)

(72) Inventors: Kenta IMAMOTO, Niigata (JP); Yoshihiro KIGAMI, Kanagawa (JP)

(73) Assignee: MITSUBISHI CHEMICAL CORPORATION, Tokyo (JP)

(21) Appl. No.: 14/698,215

(22) Filed: Apr. 28, 2015

Related U.S. Application Data
(63) Continuation of application No. PCT/JP2013/079171, filed on Oct. 28, 2013.

(30) Foreign Application Priority Data
Oct. 29, 2012 (JP) 2012-237958

(51) Int. Cl. G03G 9/097; G03G 9/087

(52) U.S. Cl. CPC G03G 9/09733; G03G 9/08755

(57) ABSTRACT

The present invention relates to an electrostatic image developing toner comprising a binder resin, a coloring agent, and a wax, wherein the toner further comprises a specific charge control resin, and the wax contains an ester wax.

### FIELD OF THE INVENTION

The present invention relates to an electrostatic image developing toner, and to an electrophotographic cartridge provided with the electrostatic image developing toner, and to an image forming device.

### BACKGROUND OF THE INVENTION

Production of an electrostatic image developing toner by a pulverization method involves kneading raw materials such as a binder resin and a coloring agent, and pulverizing and classifying the resulting mixture to obtain a component of a desired particle diameter. For recording such as by electrophotographic recording and electrostatic recording, a latent image formed on an optical semiconductor is developed with an electrostatic image developing toner, transferred onto a recording material such as paper, and heat fixed to obtain a fixed image.

A toner is typically mixed with wax to prevent toner adhesion to a fixing roller, and paper winding. For energy saving purposes, there has been used low-melting-point waxes, or toners containing increased amounts of wax to allow heat fixing at lower temperatures. However, it is generally known that a low-melting-point wax is not always easily dispersible, and that use of such waxes in large quantities to achieve low temperature fixing causes harmful effects such as poor wax dispersibility, photoreceptor contamination (filming), and poor fixed image glossiness.

In the case of full-color printing, a fixed image is obtained by layering toners of four or three different colors such as yellow, magenta, cyan, and black toners, and yellow, magenta, and cyan toners. Toners required for forming such a full-color image need to exhibit desirable fixability regardless of whether these are individually developed and adhere to a printing paper in small amounts, or developed together in layers and adhere to a printing paper in large amounts. Full-color printing often involves printing of photographic images, and requires a high gloss fixed image.

For example, Patent Literature 1 discloses a method that satisfies fixability and fixed image glossiness with a toner that uses a linear polyester having a softening point of 90 to 120° C., and a carnauba wax. Patent Literature 2 discloses a toner obtained by adding 7.0 to 20 weight % of wax to a polylactic acid biodegradable resin and a terpene phenol copolymer resin.

### CITATION LIST

### Patent Literature

### PTL 1: JP-A-08-220808

### PTL 2: JP-A-2003-248339

### SUMMARY OF THE INVENTION

### Technical Problem

However, studies by the present inventors revealed that the methods described in Patent Literatures 1 and 2 involve problems such as offset generation caused when toner adheres to a printing paper in large amounts, and need improvements in fixability and fixed image glossiness.

Under these circumstances, it is an object of the present invention to provide an electrostatic image developing toner that has an excellent fixing temperature range, and that can produce a high gloss fixed image.

### Solution to Problem

The present inventors conducted extensive studies to achieve the foregoing object, and found that the problems can be solved with a toner that contains a conventional ester wax and a specific charge control resin selected from conventional charge control agents. The present invention has been completed on the basis of this finding.

Specifically, the gist of the present invention is as follows.

<1> An electrostatic image developing toner comprising a binder resin, a coloring agent, and a wax, wherein the toner further comprises a charge control resin represented by the following formula (1), and the wax contains an ester wax:

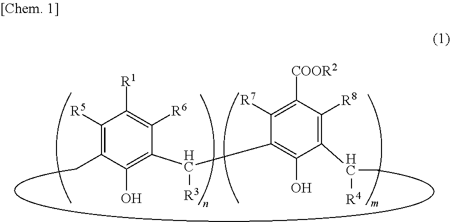

wherein R¹ represents a hydrogen atom, a halogen atom, alkyl group, —COCₚH₂ₚ₊₁ (p is an integer of 1 to 20), aralkyl group, substituted or unsubstituted phenyl group, substituted or unsubstituted amino group, nitro group, an alicyclic group, —SO₃H, —Si(CH₃)₃, alkoxyl group, carboxyl group, sulfonamide group, cyano group, or acyl group; R² represents alkyl group, substituted or unsubstituted phenyl group, or substituted or unsubstituted aralkyl group; R³ and R⁴ each independently represent a hydrogen atom, alkyl group of 1 to 12 carbon atoms, substituted or unsubstituted phenyl group, or a heterocyclic group containing a nitrogen or an oxygen atom; R⁵ to R⁸ each independently represent a hydrogen atom, a halogen atom, alkyl group, aralkyl group, or substituted or unsubstituted amino group; (m+n) is an integer of 4 to 8; m is an integer of 1 or more; and n is an integer of 0 or more.
<2> The electrostatic image developing toner according to the <1> above, wherein the content of the ester wax in the wax is 50 weight % or more.
<3> The electrostatic image developing toner according to the <1> or <2> above, wherein the content of the charge control resin represented by the formula (1) in the toner is 0.1 weight % to 2.5 weight %.
<4> An electrophotographic cartridge comprising the electrostatic image developing toner of any one of the <1> to <3> above.
<5> An image forming device comprising the electrostatic image developing toner of any one of the <1> to <3> above.

### Advantageous Effects of Invention

The present invention enables producing a fixed image having desirable fixability and high glossiness with an electrostatic image developing toner that contains an ester wax and a specific charge control resin.

### DETAILED DESCRIPTION OF THE INVENTION

The present invention is described below in detail. It should be noted that the present invention is not limited by the following embodiment, and may be modified in any ways within the scope of the gist of the present invention.

In the following, “electrostatic image developing toner” may also be referred to simply as “toner”. As used herein, “weight parts” and “mass parts” have the same meaning.

The toner of the present invention contains a binder resin, a coloring agent, a wax, and a charge control resin, and a toner matrix is obtained typically by using a melt knead pulverization method. The melt knead pulverization method is a method in which components such as a wax, a charge control agent, and a magnetic body are dry mixed with a binder resin and a coloring agent, as required, and the mixture is melt kneaded with an extruder or like, and pulverized and classified to obtain a toner matrix.

The toner can be obtained by attaching or fixing an external additive to the surface of the toner matrix so obtained.

The binder resin used to form the toner of the present invention is not particularly limited. Examples of the binder resin usable in the present invention include saturated or unsaturated polyester resin, styrene-acrylic copolymer resin, vinyl resin, phenolic resin, epoxy resin, polyethylene resin, polypropylene resin, ionomer resin, polyurethane resin, silicon resin, ketone resin, ethylene-acrylate copolymer, xylene resin, polyvinyl butyral resin, styrene-alkyl acrylate copolymer, styrene-alkyl methacrylate copolymer, styrene-acrylonitrile copolymer, styrene-butadiene copolymer, and styrene-maleic acid anhydride copolymer. These binder resins may be used either alone or in combination.

The coloring agent used for the toner of the present invention may be appropriately selected from known coloring agents usable for toners. Specific examples of such coloring agents include any of various known coloring agents such as carbon black, aniline blue, phthalocyanine blue, phthalocyanine green, Hansa yellow, rhodamine dye pigments, chromium yellow, quinacridone, benzidine yellow, rose bengal, triarylmethane dye pigments, monoazo dye pigments, disazo dye pigments, and condensed azo dye pigments. These may be used either alone or in combination.

In the case of a full-color toner, it is preferable to use benzidine yellow, a monoazo dye pigment, and a condensed azo dye pigment as yellow dye pigments, quinacridone, and a monoazo dye pigment as magenta dye pigments, and phthalocyanine blue as a cyan dye pigment. Either a carbon black, or a mixture of the yellow dye pigment, the magenta dye pigment, and the cyan dye pigment adjusted to black is used as a black dye pigment.

The carbon black as a black dye pigment exists as an aggregate of very fine primary particles, and tends to generate coarse particles through reaggregation upon being dispersed in the form of a dye pigment dispersion. There is a correlation between the extent of carbon black particle reaggregation and the amounts of impurities contained in carbon black (the extent of residual undecomposed organic materials), and the reaggregation occurring after dispersing the particles tended to cause more severe coarsening when impurity amounts were large. Impurity amounts can be quantitatively evaluated in terms of a ultraviolet absorbance of a toluene extract of carbon black. The preferred ultraviolet absorbance is 0.05 or less, more preferably 0.03 or less as measured by the method described below.

Carbon blacks produced by a channel method typically contain large amounts of impurities, and the carbon black used in the present invention should preferably be one produced by using a furnace method.

The wax used in the toner of the present invention contains an ester wax. The ester wax is a wax containing an ester group, and may be a natural ester wax or a synthetic ester wax, or a combination of different ester waxes.

Examples of the natural ester wax include carnauba wax, montan wax, and rice wax.

Examples of the synthetic ester wax include fatty acid esters formed from a fatty acid of 16 to 22 carbon atoms and a monohydric or polyhydric alcohol, mixtures of such fatty acid esters, fatty acid amides formed from a fatty acid of 16 to 22 carbon atoms and an amine, and mixtures of such fatty acid amides. Specific examples include the NOF Corporation products WEP-2, WEP-3, WEP-4, WEP-5, WEP-6, WEP-7, WEP-8, and WE-10.

For high temperature preservability and releasability, the ester wax is preferably a synthetic ester wax, more preferably a fatty acid ester formed from a fatty acid of 16 to 22 carbon atoms and a monohydric or polyhydric alcohol, or a mixture of such fatty acid esters.

When using the natural ester wax and the synthetic ester in combination or as a mixture, a natural ester wax such as a carnauba wax, a montan wax, and a rice wax may be used with a synthetic ester wax such as a fatty acid ester formed from a fatty acid of 16 to 22 carbon atoms and a monohydric or polyhydric alcohol, a mixture of such fatty acid esters, a fatty acid amide formed from a fatty acid of 16 to 22 carbon atoms and an amine, and a mixture of such fatty acid amides. Specific examples of such mixtures of a natural ester wax and a synthetic ester include the NOF Corporation product WEP-9.

When using the existing natural ester wax and the existing synthetic ester wax in combination, it is possible to use at least one of the foregoing natural ester waxes, and at least one synthetic ester wax selected from products such as the NOF Corporation products WEP-2, WEP-3, WEP-4, WEP-5, WEP-6, WEP-7, WEP-8, and WE-10 in appropriately adjusted proportions.

When using the natural ester wax and the synthetic ester in combination or as a mixture, these may be individually added, or may be added as a mixture when being mixed with the toner matrix raw material by methods such as melt kneading and pulverization to produce the toner matrix.

The melting point of the ester wax is not particularly limited, as long as it is not detrimental to the effects of the present invention. The lower limit is typically 50° C. or more, preferably 60° C. or more from the standpoint of high temperature preservability. The upper limit is typically 100° C. or less, preferably 90° C. or less from the standpoint of low temperature fixability.

The lower limit of the wax content is typically 0.5 weight % or more with respect to the toner, preferably 1.5 weight % or more from the standpoint of non-hot offset temperature range. The upper limit is typically 10 weight % or less, preferably 6 weight % or less, more preferably 5 weight % or less from the standpoint of preventing problems such as fusing to the sleeve or blade during endurance printing, or filming of the photoreceptor.

The toner of the present invention may contain waxes other than the ester wax, as long as it is not detrimental to the effects of the present invention. It is, however, particularly preferable that the wax is of solely an ester wax.

Examples of waxes that may be used with the ester wax include paraffin wax, Fischer-Tropsch wax, and olefin wax.

When using the ester wax in combination with other waxes, the ester wax content is not particularly limited, as long as it is not detrimental to the effects of the present invention. However, the ester wax content is preferably 50 weight % or more, more preferably 75 weight % or more with respect to the total wax amount from the standpoint of exhibiting the effects of the present invention.

The charge control resin contained in the present invention is represented by the following formula (1).

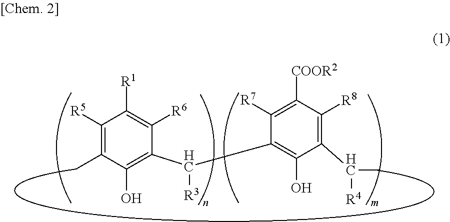

In formula (1), R¹ represents a hydrogen atom, a halogen atom, alkyl group, —COCₚH₂ₚ₊₁ (p is an integer of 1 to 20), aralkyl group, substituted or unsubstituted phenyl group, substituted or unsubstituted amino group, nitro group, an alicyclic group, —SO₃H, —Si(CH₃)₃, alkoxyl group, carboxyl group, sulfonamide group, cyano group, or acyl group.

R¹ is preferably alkyl group, more preferably alkyl group of 1 to 8 carbon atoms. When R¹ is alkyl group, the lower limit of the number of carbon atoms is further preferably 3 or more. The upper limit of the number of carbon atoms is further preferably 6 or less, particularly preferably 4 or less. When the alkyl group has 3 or more carbon atoms, the alkyl group may be linear or branched, and is preferably branched. R¹ is most preferably t-butyl.

R² represents alkyl group, substituted or unsubstituted phenyl group, or substituted or unsubstituted aralkyl group.

R² is preferably alkyl group, more preferably alkyl group of 1 to 12 carbon atoms. When R² is alkyl group, the lower limit of the number of carbon atoms is further preferably 3 or more. The upper limit of the number of carbon atoms is further preferably 10 or less, particularly preferably 8 or less. When the alkyl group has 3 or more carbon atoms, the alkyl group may be linear or branched, and is preferably branched. R² is most preferably 2-ethylhexyl.

R³ and R⁴ each independently represent a hydrogen atom, alkyl group of 1 to 12 carbon atoms, substituted or unsubstituted phenyl group, or a heterocyclic group containing a nitrogen or an oxygen atom.

R³ and R⁴ are preferably hydrogen atoms.

R⁵ to R⁸ each independently represent a hydrogen atom, a halogen atom, alkyl group, aralkyl group, or substituted or unsubstituted amino group.

R⁵ to R⁸ are preferably hydrogen atoms.

(m+n) is an integer of 4 to 8, m is an integer of 1 or more, and n is an integer of 0 or more.

The lower limit of the content of the charge control resin as the compound represented by the foregoing formula (1) is typically 0.1 weight % or more, preferably 0.5 weight % or more with respect to the toner. The upper limit is typically 2.5 weight % or less, preferably 1.5 weight % or less.

The toner of the present invention may contain charge control agents other than the charge control resin represented by the formula (1), provided that it is not detrimental to the effects of the present invention. Examples of charge control agents other than the charge control resin represented by the formula (1) include charge control agents formed from materials such as azine compounds (nigrosines), quarternary ammonium salt compounds, 2:1-type metal-containing complexes (chromium complexes), and monoazo-containing metal complex compounds. Other examples include charge control agents formed of resins other than the charge control resin represented by the formula (1).

When the charge control resin represented by the formula (1) is used with other charge control agents, the content of the charge control agent used is not particularly limited. The total content of the charge control agents with respect to the toner is typically 0.1 weight % or more, preferably 0.25 weight % or more, and is typically 5 weight % or less, preferably 2 weight % or less.

The toner of the present invention may also contain external additives, as required. External additives may be appropriately selected from known external additives usable for toners.

External additives may contain, for example, one or more kinds of hydrophobic silica, inorganic oxide fine particles, and organic fine particles. Examples of the inorganic oxide fine particles include inorganic particles of titanium oxide, aluminum oxide, magnetite, zinc oxide, tin oxide, barium titanate, and strontium titanate. Examples of the organic fine particles include fine particles of styrene resin, acrylic resin, epoxy resin, and melamine resin.

When using external additives in the present invention, the external additive content is not particularly limited, and is typically 0.1 weight % or more, preferably 0.5 weight % or more, more preferably 0.8 weight % or more, and is typically 6 weight % or less, preferably 5 weight % or less, more preferably 4 weight % or less with respect to the toner matrix particles.

External additives may be added by using methods, for example, such as a method using a high-speed agitator such as a Henschel mixer, and a method that uses a device capable of applying compression shear stress.

A toner containing external additives may be produced by using a batch method whereby all the external additives are simultaneously added to the toner matrix particles, or by using a non-batch method whereby the external additives are added in separate portions to the toner matrix particles.

In order to prevent temperature increase during addition, it is preferable to install a cooling device in the container used, or add external additives in separate portions.

The toner of the present invention is charged into a container such as an electrophotographic cartridge and a toner bottle, and installed in an image forming device. The toner of the present invention may be used for known electrophotographic cartridges and image forming devices.

### EXAMPLES

The present invention is described below in greater detail using Examples. However, the present invention is not limited by the following Examples, as long as the following descriptions do not depart from the gist of the invention. In the following, “part” means “part by mass.”

### <Fixability Evaluation>

All tests used a standard paper (whiteness level 92%, paper thickness 0.087 μm, basis weight 64 g/m², size A4 (297 mm×210 mm)).

The fixing unit of a commercially available 2-component copier was removed, and an unfixed image was obtained. Toner adhesion to the paper was adjusted to about 0.5 mg/cm² and about 1.3 mg/cm².

The unfixed image was fixed with an external fixing unit after adjusting the heat fixing roller temperature and the process speed, and visually inspected for the presence or absence of an offset to evaluate fixability. The notation “S” and “F” are used to indicate an absence and a presence of an offset, respectively. The fixing unit of the multifunction printer AR-C261 (Sharp) was used as the external fixing unit after removing it from the printer.

Images with the adhesion amount of about 0.5 mg/cm² were evaluated at the adjusted process speed of 70 mm/s, and the adjusted heat fixing roller temperatures of 140° C. and 150° C.

Images with the adhesion amount of about 1.3 mg/cm² were evaluated at the adjusted process speed of 70 mm/s, and the adjusted heat fixing roller temperatures of 190° C. to 220° C. in 10° C. increments.

### <Gloss Performance Evaluation>

Fixed images were obtained in the same manner as in the fixability evaluation. Toner adhesion was adjusted to about 0.5 mg/cm², and the external fixing unit was used at the adjusted process speed of 70 mm/s, and the adjusted heat fixing roller temperature of 180° C. The fixed images were then evaluated for gloss performance. The glossiness of the solid portion was measured in terms of a 75° mirror gloss with a Gloss Meter VG2000 (Nippon Denshoku Industries Co., Ltd.).

The results are evaluated as “S” when the glossiness was 9% or more, and “F” when it was less than 9%.

### Example 1

A negatively charged non-magnetic toner was produced in the following mixture ratio.
Resin A (polyester, softening point 147° C., glass transition point 60° C., gel component 40%), 60 parts (55.3 weight %)
Resin B (polyester, softening point 100° C., glass transition point 64° C., gel component 0%), 34 parts (31.3 weight %)
Master batch A (resin B:Pigments Blue=15:3=60 parts:40 parts), 10 parts (9.2 weight %)
Silica (R972v, Nippon Aerosil Co., Ltd.), 1 part (0.9 weight %)
Wax A (ester wax, WEP-9, NOF Corporation), 2.5 parts (2.3 weight %)
Charge control agent A (aromatic polycondensate of the following formula (2); charge control resin), 1 part (0.9 weight %)

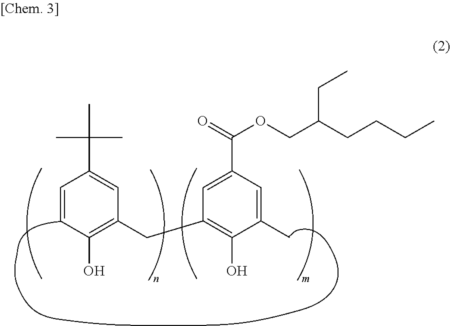

The charge control agent A represented by the formula (2) is a compound that can be obtained according to Example 4 of JP-A-2004-279838.

The raw materials were mixed with a Henschel mixer, melt kneaded with a biaxial extruder, and coarsely pulverized. The particles were then finely pulverized with a jet mill pulverizer, and classified to obtain a toner matrix having a volume average particle diameter of 8 μm.

An electrostatic image developing toner was obtained after mixing external additives in the following mixture ratio with a high speed mixer.
Toner matrix: 100 parts (97.7 weight %)
Hydrophobic silica A: 1.0 part (1.0 weight %)
Hydrophobic silica B: 0.7 parts (0.7 weight %)
Titanium oxide A: 0.3 parts (0.3 weight %)
Titanium oxide B: 0.3 parts (0.3 weight %)

### Comparative Example 1

A toner was obtained in the same manner as in Example 1, except that the charge control agent A was replaced with charge control agent B.
Charge control agent B (sulfonic acid CCR, FCA-1002NS, Fujikura Kasei Co., Ltd.)

### Comparative Example 2

A toner was obtained in the same manner as in Example 1, except that the charge control agent A was replaced with charge control agent C.
Charge control agent C (boron metal complex, LR-147, Japan Carlit Co., Ltd.)

### Comparative Example 3

A toner was obtained in the same manner as in Example 1, except that the charge control agent A was not added.

### Example 2

A negatively charged non-magnetic toner was produced in the following mixture ratio.
Resin A (polyester, softening point 147° C., glass transition point 60° C., gel component 40%), 60 parts (54.3 weight %)
Resin B (polyester, softening point 100° C., glass transition point 64° C., gel component 0%), 31 parts (28.1 weight %)
Master batch B (resin B:Pigments Red=57:1=60 parts:40 parts), 15 parts (13.5 weight %)
Silica (R972v, Nippon Aerosil Co., Ltd.), 1 part (0.9 weight %)
Wax A (ester wax, WEP-9, NOF Corporation), 2.5 parts (2.3 weight %)
Charge control agent A (aromatic polycondensate represented by the following formula (2); charge control resin), 1 part (0.9 weight %)

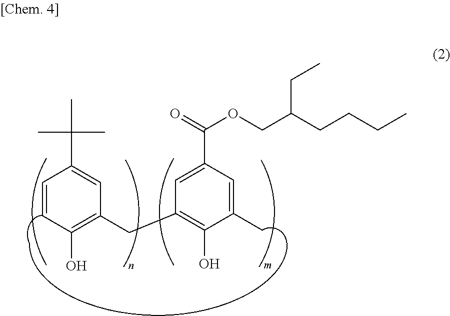

The raw materials were mixed with a Henschel mixer, melt kneaded with a biaxial extruder, and coarsely pulverized. The particles were then finely pulverized with a jet mill pulverizer, and classified to obtain a toner matrix having a volume average particle diameter of 8 μm.

An electrostatic image developing toner was obtained after mixing external additives in the following mixture ratio with a high speed mixer.
Toner matrix: 100 parts (97.7 weight %)
Hydrophobic silica A: 1.0 part (1.0 weight %)
Hydrophobic silica B: 0.7 parts (0.7 weight %)
Titanium oxide A: 0.5 parts (0.5 weight %)
Titanium oxide B: 0.1 parts (0.1 weight %)

### Example 3

A toner was obtained in the same manner as in Example 2, except that wax A was replaced with wax B.
Wax B (ester wax, WEP-5, NOF Corporation).

### Example 4

A toner was obtained in the same manner as in Example 2, except that wax A was replaced with wax C.
Wax C (ester wax, WEP-10, NOF Corporation).

### Comparative Example 4

A toner was obtained in the same manner as in Example 2, except that wax A was replaced with wax D.
Wax D (paraffin wax, HNP-9PD, Nippon Seiro Co., Ltd.)

### Comparative Example 5

A toner was obtained in the same manner as in Example 2, except that wax A was replaced with wax E.
Wax E (polyethylene wax, Hi-Wax 1120H, Mitsui Chemicals, Inc.)

### Comparative Example 6

A toner was obtained in the same manner as in Example 2, except that wax A was replaced with waxes E and F. These were added in the following amounts.
Wax E (polyethylene wax, Hi-Wax 1120H, Mitsui Chemicals, Inc.), 1.5 parts
Wax F (polypropylene wax, Viscol 550-P, Sanyo Chemical Industries), 1.0 part

### Comparative Example 7

A toner was obtained in the same manner as in Example 1, except that the charge control agent A was replaced with charge control agent D.
Charge control agent D (calixarene, E-89, Orient Chemical Industries., Co., Ltd.)

The toners produced in Example 1, Comparative Examples 1 to 3, and Comparative Example 7 were evaluated for their compositions and the foregoing criteria. The results are presented in Table-1. The toners produced in Examples 2 to 4, and Comparative Examples 4 to 6 were evaluated for their compositions and the foregoing criteria. The results are presented in Table-2.

TABLE 1

| | | Com. | Com. | Com. | Com. |
|---|---|---|---|---|---|
| | Ex. 1 | Ex. 1 | Ex. 2 | Ex. 3 | Ex. 7 |
| Resin A | 60 | 60 | 60 | 60 | 60 |
| Resin B | 34 | 34 | 34 | 34 | 34 |
| Master batch A | 10 | 10 | 10 | 10 | 10 |
| Silica | 1 | 1 | 1 | 1 | 1 |
| Wax A | 2.5 | 2.5 | 2.5 | 2.5 | 2.5 |
| Wax B | | | | | |
| Wax C | | | | | |
| Wax D | | | | | |
| Wax E | | | | | |
| Wax F | | | | | |
| Charge control | 1 | | | | |
| agent A | | | | | |
| Charge control | | 1 | | | |
| agent B | | | | | |
| Charge control | | | 1 | | |
| agent C | | | | | |
| Charge control | | | | | 1 |
| agent D | | | | | |

Fixing performance
Adhesion amount 1.5 mg/cm²

| | | | | | |
|---|---|---|---|---|---|
| 140° C. | S | S | S | S | — |
| 150° C. | S | F | S | S | — |

Adhesion amount 0.5 mg/cm²

| | | | | | |
|---|---|---|---|---|---|
| 190° C. | S | S | S | S | S |
| 200° C. | S | F | S | S | F |
| 210° C. | S | F | F | F | F |
| 220° C. | S | — | — | F | — |

Gloss performance

| | | | | | |
|---|---|---|---|---|---|
| Glossiness | 13.1 | 7.3 | 8.4 | 7.2 | 13.2 |
| | S | F | F | F | S |

As can be seen in Table-1, it was confirmed that the toner of the present invention had excellent fixability and produced high gloss images as compared to toners in which charge control resins other than the charge control resin of the present invention were used (Comparative Examples 1 and 7), a toner in which a conventional metal-complex charge control agent was used (Comparative Example 2), and a toner in which a charge control agent was not added (Comparative Example 3).

TABLE 2

| | | | | Com. | Com. | Com. |
|---|---|---|---|---|---|---|
| | Ex. 2 | Ex. 3 | Ex. 4 | Ex. 4 | Ex. 5 | Ex. 6 |
| Resin A | 60 | 60 | 60 | 60 | 60 | 60 |
| Resin B | 34 | 34 | 34 | 34 | 34 | 34 |
| Master batch B | 10 | 10 | 10 | 10 | 10 | 10 |
| Silica | 1 | 1 | 1 | 1 | 1 | 1 |
| Wax A | 2.5 | | | | | |
| Wax B | | 2.5 | | | | |
| Wax C | | | 2.5 | | | |
| Wax D | | | | 2.5 | | |
| Wax E | | | | | 2.5 | 1.5 |
| Wax F | | | | | | 1.0 |
| Charge control | 1 | 1 | 1 | 1 | 1 | 1 |
| agent A | | | | | | |
| Charge control | | | | | | |
| agent B | | | | | | |
| Charge control | | | | | | |
| agent C | | | | | | |

Fixing performance
Adhesion amount 1.5 mg/cm²

| | | | | | | |
|---|---|---|---|---|---|---|
| 140° C. | S | S | S | S | F | F |
| 150° C. | S | S | S | S | Jam | F |

Adhesion amount 0.5 mg/cm²

| | | | | | | |
|---|---|---|---|---|---|---|
| 190° C. | S | S | S | S | S | S |
| 200° C. | S | S | S | S | S | S |
| 210° C. | S | S | S | S | S | S |
| 220° C. | S | S | S | S | S | S |

Gloss performance

| | | | | | | |
|---|---|---|---|---|---|---|
| Glossiness | 10.7 | 9.4 | 9.4 | 6.8 | 5.1 | 7.1 |
| | S | S | S | F | F | F |

As can be seen in Table-2, it was confirmed that the toners of the present invention produced high gloss images as compared to a toner in which a paraffin wax having about the same melting point as an ester wax was used (Comparative Example 4). It was also confirmed that the toners of the present invention had excellent fixability and produced high gloss images as compared to toners in which other waxes were used (Comparative Examples 5 and 6).

It can be seen from the results presented in Table-1 and Table-2 that a toner having excellent fixability and producing a high gloss image even in large adhesion amounts can be provided when the toner contains a conventional ester wax, and a specific charge control agent selected from conventional charge control agents.

While there has been described a certain embodiment of the invention, it will be apparent to a skilled person that various alterations and modifications may be made thereto within the spirit and scope of the invention.

This application is based on Japanese patent application No. 2012-237958 filed Oct. 29, 2012, the entire contents of which are hereby incorporated by reference.

1. An electrostatic image developing toner comprising a binder resin, a coloring agent, and a wax, wherein the toner further comprises a charge control resin represented by the following formula (1), and the wax contains an ester wax: 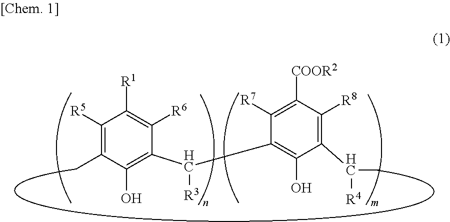
wherein R¹ represents a hydrogen atom, a halogen atom, alkyl group, —COCₚH₂ₚ₊₁ (p is an integer of 1 to 20), aralkyl group, substituted or unsubstituted phenyl group, substituted or unsubstituted amino group, nitro group, an alicyclic group, —SO₃H, —Si(CH₃)₃, alkoxyl group, carboxyl group, sulfonamide group, cyano group, or acyl group; R² represents alkyl group, substituted or unsubstituted phenyl group, or substituted or unsubstituted aralkyl group; R³ and R⁴ each independently represent a hydrogen atom, alkyl group of 1 to 12 carbon atoms, substituted or unsubstituted phenyl group, or a heterocyclic group containing a nitrogen or an oxygen atom; R⁵ to R⁸ each independently represent a hydrogen atom, a halogen atom, alkyl group, aralkyl group, or substituted or unsubstituted amino group; (m+n) is an integer of 4 to 8; m is an integer of 1 or more; and n is an integer of 0 or more.

2. The electrostatic image developing toner according to claim 1, wherein the content of the ester wax in the wax is 50 weight % or more.

3. The electrostatic image developing toner according to claim 1, wherein the content of the charge control resin represented by the formula (1) in the toner is 0.1 weight % to 2.5 weight %.

4. An electrophotographic cartridge comprising the electrostatic image developing toner of claim 1.

5. An image forming device comprising the electrostatic image developing toner of claim 1.
